(19) United States
(12) Patent Application Publication
(10) Pub. No.: US 2010/0136294 A1
(43) Pub. Date: Jun. 3, 2010

(54) FIBROUS STRUCTURES COMPRISING A LOTION AND METHODS FOR MAKING SAME

(76) Inventors: John Allen Manifold, Milan, IN (US); Kathleen Diane Sands, West Chester, OH (US); David Mark Rasch, Cincinnati, OH (US); Jeremy Howard Nugent, Liberty Township, OH (US); Christopher Gerald Donner, Liberty Township, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/624,452

(22) Filed: Nov. 24, 2009

Related U.S. Application Data
(60) Provisional application No. 61/119,492, filed on Dec. 3, 2008.

(51) Int. Cl. B32B 29/06; D21H 27/30; B32B 3/00; B32B 37/00

(52) U.S. Cl. 428/171; 428/535; 442/59; 428/485; 428/195.1; 428/211.1; 428/172; 156/278

(57) ABSTRACT

Lotion-containing fibrous structures and more particularly lotion-containing multi-ply fibrous structures and methods for making such fibrous structures are provided.

### CROSS REFERENCE TO RELATED APPLICATION(S)

This application claims the benefit of U.S. Provisional Application No. 61/119,492, filed Dec. 3, 2008.

### FIELD OF THE INVENTION

The present invention relates to fibrous structures comprising a lotion and more particularly to multi-ply fibrous structures comprising a lotion and method for making such fibrous structures.

### BACKGROUND OF THE INVENTION

Single-ply and multi-ply lotioned fibrous structures are known in the art. For example, Charmin® Plus is a lotioned single-ply bath tissue. There are other examples of lotioned fibrous structures, for example lotioned facial tissue such as Puffs® Plus is a lotioned two-ply facial tissue where the two plies are combined together without an adhesive via knurled wheel rolls. The previous executions of lotioned fibrous structures have their drawbacks, especially when a multi-ply lotioned fibrous structure is intended for use as a bath tissue.

Accordingly, there exists a need for fibrous structures, especially multi-ply fibrous structures, comprising a lotion that overcome the negatives associated with known lotioned fibrous structures and methods for making such fibrous structures, especially such multi-ply fibrous structures.

### SUMMARY OF THE INVENTION

The present invention fulfills the need described above by providing fibrous structures comprising a lotion and methods for making such fibrous structures.

In one example of the present invention, a multi-ply fibrous structure comprising a first fibrous structure ply and a second fibrous structure ply plybonded together by an adhesive wherein the multi-ply fibrous structure further comprises a lotion, is provided.

In another example of the present invention, a method for making a multi-ply fibrous structure according to the present invention, the method comprising the steps of:

a. plybonding a first fibrous structure ply with a second fibrous structure ply with an adhesive to form a multi-ply fibrous structure; and

b. applying a lotion to at least one of the first and second fibrous structure plies, is provided.

In yet another example of the present invention, a fibrous structure comprising a lotion, wherein the fibrous structure exhibits a HFS of greater than 18.2 g/g and/or greater than 18.5 g/g and/or greater than 18.75 g/g and/or greater than 19 g/g and/or greater than 19.5 g/g, is provided.

In even another example of the present invention, a fibrous structure comprising a lotion wherein the fibrous structure exhibits a VFS of greater than 9.7 g/g and/or greater than 10 g/g and/or greater than 10.2 g/g and/or greater than 10.5 g/g, is provided.

Accordingly, the present invention provides fibrous structures comprising a lotion and methods for making such fibrous structures.

### BRIEF DESCRIPTION OF THE DRAWINGS

FIG. 1 is a schematic representation of an example of a fibrous structure according to the present invention;

FIG. 2 is a schematic representation of an example of a multi-ply fibrous structure according to the present invention;

FIG. 3 is a schematic representation of another example of a multi-ply fibrous structure according to the present invention;

FIG. 4 is a schematic representation of an example of a process for making a multi-ply fibrous structure according to the present invention;

FIG. 5 is a diagram of a support rack utilized in the HFS and VFS Test Methods described herein; and

FIG. 6 is a diagram of a support rack cover utilized in the HFS and VFS Test Methods described herein.

### DETAILED DESCRIPTION OF THE INVENTION

### Definitions

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products), cardboard, paperboard and mixtures thereof.

Non-limiting examples of processes for making fibrous structures include known wet-laid papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed.

For example, in typical papermaking processes, the finished fibrous structure is the fibrous structure that is wound on the reel at the end of papermaking, and may subsequently be converted into a finished product, e.g. a sanitary tissue product.

The fibrous structure of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the fibrous structure of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The fibrous structure of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the fibrous structure of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the fibrous structure exhibits a total dry tensile strength of less than about 394 g/cm (1000 g/in) and/or less than about 335 g/cm (850 g/in).

In another example, the fibrous structure of the present invention may exhibit a total dry tensile strength of greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The fibrous structure of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The fibrous structure of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The fibrous structure of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The fibrous structure of the present invention may be in the form of fibrous structure rolls. Such fibrous structure rolls may comprise a plurality of connected, but perforated sheets of fibrous structure, that are separably dispensable from adjacent sheets. In one example, one or more ends of the roll of fibrous structure may comprise an adhesive and/or dry strength agent to mitigate the loss of fibers, especially wood pulp fibers from the ends of the roll of fibrous structure.

The fibrous structure of the present invention may comprise a through-air-dried fibrous structure. The fibrous structure may be creped or uncreped. The fibrous structure may be a differential density fibrous structure wherein the fibrous structure comprises regions of different densities.

The fibrous structure of the present invention may comprise one or more additives such as softening agents, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on fibrous structure.

The fibrous structure may comprise a pattern created in converting, such as by embossing and/or created during papermaking, such as by molding into a patterned belt.

“Fiber” and/or “Filament” as used herein means an elongate particulate having an apparent length greatly exceeding its apparent width, i.e. a length to diameter ratio of at least about 10. For purposes of the present invention, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include natural polymers, such as starch, starch derivatives, cellulose and cellulose derivatives, hemicellulose, hemicellulose derivatives, and synthetic polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking.

In addition to the various wood pulp fibers, other cellulosic fibers such as cotton linters, rayon, lyocell and bagasse can be used in this invention. Other sources of cellulose in the form of fibers or capable of being spun into fibers include grasses and grain sources.

“Sanitary tissue product” as used herein means a soft, low density (i.e. <about 0.15 g/cm³) web useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m².

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply fibrous structure and/or multi-ply sanitary tissue product. It is also contemplated that an individual, integral fibrous structure can effectively form a multi-ply fibrous structure, for example, by being folded on itself.

As used herein, the articles “a” and “an” when used herein, for example, “an anionic surfactant” or “a fiber” is understood to mean one or more of the material that is claimed or described.

All percentages and ratios are calculated by weight unless otherwise indicated. All percentages and ratios are calculated based on the total composition unless otherwise indicated.

Unless otherwise noted, all component or composition levels are in reference to the active level of that component or composition, and are exclusive of impurities, for example, residual solvents or by-products, which may be present in commercially available sources.

### Fibrous Structure

The fibrous structure of the present invention comprises a lotion. The fibrous structure may comprise greater than 0.5% and/or at least about 1% and/or at least about 1.5% and/or at least about 2% and/or at least about 5% and/or at least about 10% and/or less than about 50% and/or less than about 30% and/or less than about 20% by weight of the fibrous structure of a lotion. In one example, the fibrous structure may comprise from greater than 0.5% to less than about 50% and/or from at least about 1% to less than about 30% and/or from at least about 1.5% to less than about 20% by weight of the fibrous structure of a lotion.

In one example, the fibrous structure of the present invention comprises a multi-ply fibrous structure. The multi-ply fibrous structure comprises two or more fibrous structure plies. In one example, the multi-ply fibrous structure of the present invention comprises a first fibrous structure ply and a second fibrous structure ply plybonded together by an adhesive wherein the multi-ply fibrous structure further comprises a lotion. The plies of the multi-ply fibrous structure may be the same or different from one another. In one example, at least one of the first and second fibrous structure plies comprises a through-air-dried fibrous structure ply. In another example, at least one of the first and second fibrous structure plies comprises regions of different densities. In still another example, at least one of the first and second fibrous structure plies is uncreped.

In one example, at least one of the fibrous structure plies comprises a pattern and/or an embossment. For example, one or more of the fibrous structures of the present invention may be an embossed fibrous structure.

In another example, as shown in FIG. 1, the lotion-containing fibrous structure 10 of the present invention may comprise one or more substantially machine direction oriented linear elements 12. In addition to the one or more linear elements 12, the fibrous structure 10 may further comprise one or more non-linear elements 14. In one example, a non-linear element 14 present on the surface 16 of the fibrous structure 10 is water-resistant. In another example, a non-linear element 14 present on the surface 16 of a fibrous structure 10 comprises an embossment. When present on a surface of a fibrous structure, a plurality of non-linear elements may be present in a pattern. The pattern may comprise a geometric shape such as a polygon. Non-limiting example of suitable polygons are selected from the group consisting of: triangles, diamonds, trapezoids, parallelograms, rhombuses, stars, pentagons, hexagons, octagons and mixtures thereof.

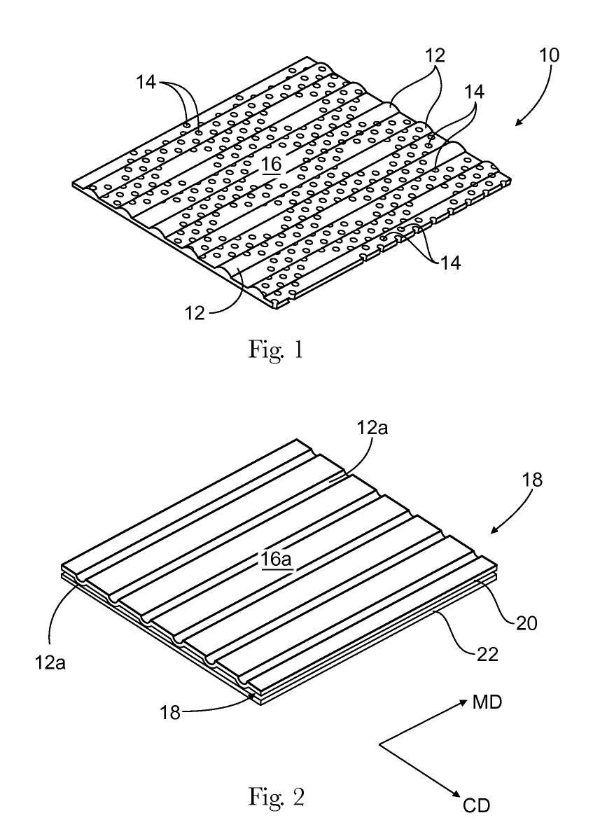

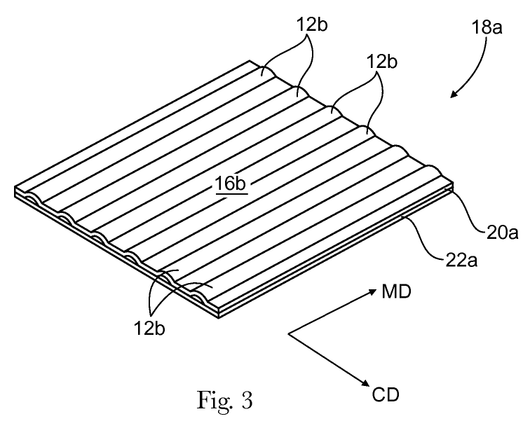

As shown in FIG. 2, a lotion-containing multi-ply fibrous structure 18 according to the present invention may comprise a first fibrous structure ply 20 and a second fibrous structure ply 22 wherein the first fibrous structure ply 20 comprises a surface 16a comprising a plurality of linear elements 12a, in this case being oriented in the machine direction or substantially machine direction oriented. The plies 20 and 22 are arranged such that the linear elements 12a extend inward into the interior of the multi-ply fibrous structure 18 rather than outward.

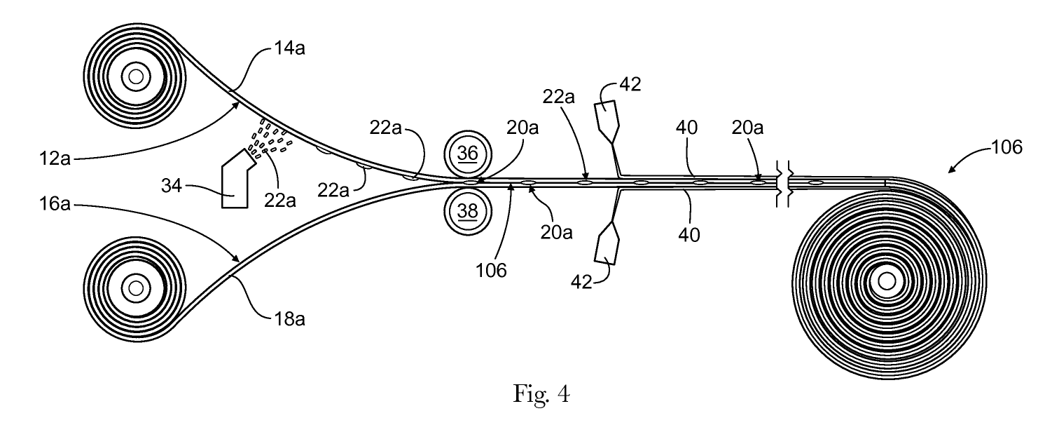

In another example, as shown in FIG. 3, a lotion-containing multi-ply fibrous structure 18a according to the present invention may comprise a first fibrous structure ply 20a and a second fibrous structure ply 22a wherein the first fibrous structure ply 20a comprises a surface 16b comprising a plurality of linear elements 12b, in this case being oriented in the machine direction or substantially machine direction oriented. The plies 20a and 22a are arranged such that the linear elements 12b extend outward from the surface 16b of the multi-ply fibrous structure 18a rather than inward.

In addition to a lotion, the fibrous structures of the present invention may comprise additional ingredients such as permanent and/or temporary wet strength agents, surface treating compositions and skin benefit agents and mixtures thereof.

### Adhesive

The adhesive of the present invention may be any suitable adhesive that creates a plybond between two or more plies of a multi-ply fibrous structure of the present invention.

The adhesive may be present in the multi-ply fibrous structure at a level of at least about 0.007% and/or at least about 0.01% by weight and/or less than about 5% by weight and/or from about 0.01% to about 2% by weight and/or from about 0.05% to about 1% and/or from about 0.05% to about 0.4% and/or from about from about 0.05% to about 0.2% by weight. In one example, the adhesive is present in the multi-ply fibrous structure at a level of about 0.1% to about 0.4% by weight.

Non-limiting examples of suitable adhesives includes cold glues, foaming glues and liquid hot melt glues. The glues may be in the form of foamed glues, spray glues and/or liquid glues and mixtures thereof.

The adhesive of the present invention may comprise a water-based adhesive. Non-limiting examples of suitable adhesives are known in the art. For example, a water-based adhesive may comprises an adhesive obtained from polymerizing ethylene and propylene monomeric units.

In one example, the adhesive of the present invention comprises a resin selected from the group consisting of: acrylic, styrene-acrylic, styrene-butadiene, vinyl acetate, polyvinyl alcohol, urethane, chloroprene, phenolic, polyamide, polyether, polyester, polysaccharides (including starch, dextrin, cellulose, gums, or the like), combinations of these, and the like. Particularly useful resin(s) are acrylic, vinyl acetate, polyvinyl alcohol, dextrin, starch, and the like.

Non-limiting examples of foamed glues include foamed glues commercially available from HB Fuller. In one example, the adhesive of the present invention comprises HB Fuller's TT5000B foamed glue. In another example, the adhesive comprises a foamed glue that comprises air cells having an average size in the range of from about 20 to 100 μm.

Non-limiting examples of spray glues include spray glues comprising polyvinyl alcohol.

Non-limiting examples of liquid hot melt glues include liquid hot melt glues commercially available from Liquid Polymer Corporation. In one example, the adhesive of the present invention comprises Liquid Polymer Corporation's Liquamelt™ LM1100 liquid hot melt glue. In another example, the adhesive of the present invention comprises a liquid hot melt glue comprising a polymeric reinforcing phase component and an adsorbent phase component. The polymeric reinforcing phase component may comprise a polymer selected from the group consisting of poly(ethylene-co-vinyl acetate), poly(ethylene-co-vinyl acetate-co-methacrylic acid)terpolymer, poly(ethylene-co-vinyl acetate-co-maleic anhydride)terpolymer and mixtures thereof. The adsorbent phase may comprise a polymer selected from the group consisting of: poly(propylene-co-maleic anhydride).

Other examples of suitable adhesives are commercially available from H.B. Fuller under the trade name WB2746 and/or from Henkel under the trade name 52-6005H.

### Lotion

The lotion may comprise oils and/or emollients and/or waxes and/or immobilizing agents. In one example, the lotion comprises from about 10% to about 90% and/or from about 30% to about 90% and/or from about 40% to about 90% and/or from about 40% to about 85% of an oil and/or emollient. In another example, the lotion comprises from about 10% to about 50% and/or from about 15% to about 45% and/or from about 20% to about 40% of an immobilizing agent. In another example, the lotion comprises from about 0% to about 60% and/or from about 5% to about 50% and/or from about 5% to about 40% of petrolatum.

The lotions may be heterogeneous. They may contain solids, gel structures, polymeric material, a multiplicity of phases (such as oily and water phase) and/or emulsified components. It may be difficult to determine precisely the melting temperature of the lotion, i.e. difficult to determine the temperature of transition between the liquid form, the quasi-liquid from, the quasi-solid form and the solid form. The terms melting temperature, melting point, transition point and transition temperature are used interchangeably in this document and have the same meaning.

The lotions may be semi-solid and/or exhibit a high viscosity so they do not substantially flow without activation during the life of the product or gel structures.

The lotions may be shear thinning and/or they may strongly change their viscosity around skin temperature to allow for transfer and easy spreading on a user's skin.

The lotions may be in the form of emulsions and/or dispersions.

In one example of a lotion, the lotion has a water content of less than about 20% and/or less than 10% and/or less than about 5% or less than about 0.5%.

In another example, the lotion may have a solids content of at least about 15% and/or at least about 25% and/or at least about 30% and/or at least about 40% to about 100% and/or to about 95% and/or to about 90% and/or to about 80%.

A non-limiting example of a suitable lotion of the present invention comprises a chemical softening agent, such as an emollient, that softens, soothes, supples, coats, lubricates, or moisturizes the skin. The lotion may sooth, moisturize, and/or lubricate a user's skin.

The lotion may comprise an oil and/or an emollient. Non-limiting examples of suitable oils and/or emollients include polyhydroxy compounds, glycols (such as propylene glycol and/or glycerine), polyglycols (such as triethylene glycol), petrolatum, fatty acids, fatty alcohols, fatty alcohol ethoxylates, fatty alcohol esters and fatty alcohol ethers, fatty acid ethoxylates, fatty acid amides and fatty acid esters, hydrocarbon oils (such as mineral oil), squalane, fluorinated emollients, silicone oil (such as dimethicone) and mixtures thereof.

As used herein, the term “polyhydroxy compounds” is defined as a chemical agent that imparts lubricity or emolliency to tissue paper products and also possesses permanence with regard to maintaining the fidelity of its deposits without substantial migration when exposed to the environmental conditions to which products of this type are ordinarily exposed during their typical life cycle. The lotion of the present invention may contain from about 2.0% to about 30.0% and/or from 5% to about 20.0% and/or from about 8.0% to about 15.0%, of a water soluble polyhydroxy compound, based on the dry fiber weight of the bonded fibrous article.

Examples of water soluble polyhydroxy compounds suitable for use in the present invention include glycerol, polyglycerols having a weight average molecular weight of from about 150 to about 800 and polyoxyethylene and polyoxypropylene having a weight-average molecular weight of from about 200 to about 4000 and/or from about 200 to about 1000 and/or from about 200 to about 600. Mixtures of the above-described polyhydroxy compounds may also be used. For example, mixtures of glycerol and polyglycerols, mixtures of glycerol and polyoxyethylenes, ‘mixtures of polyglycerols and polyoxyethylenes, etc. are useful in the present invention. One example of a suitable polyhydroxy compound is polyoxyethylene having a weight average molecular weight of about 200. This material is available commercially from the BASF Corporation of Florham Park, N.J. under the trade names “Pluriol E200” and “Pluracol E200”.

Non-limiting examples of emollients useful in the present invention can be petroleum-based, fatty acid ester type, alkyl ethoxylate type, or mixtures of these materials. Suitable petroleum-based emollients include those hydrocarbons, or mixtures of hydrocarbons, having chain lengths of from 16 to 32 carbon atoms. Petroleum based hydrocarbons having these chain lengths include petrolatum (also known as “mineral wax,” “petroleum jelly” and “mineral jelly”). Petrolatum usually refers to more viscous mixtures of hydrocarbons having from 16 to 32 carbon atoms. A suitable Petrolatum is available from Witco, Corp., Greenwich, Conn. as White Protopet® 1 S.

Suitable fatty acid ester emollients include those derived from long chain C₁₂-C₂₈ fatty acids, such as C₁₆-C₂₂ saturated fatty acids, and short chain C₁-C₈ monohydric alcohols, such as C₁-C₃ monohydric alcohols. Non-limiting examples of suitable fatty acid ester emollients include methyl palmitate, methyl stearate, isopropyl laurate, isopropyl myristate, isopropyl palmitate, and ethylhexyl palmitate. Suitable fatty acid ester emollients can also be derived from esters of longer chain fatty alcohols (C₁₂-C₂₈, such as C₁₂-C₁₆) and shorter chain fatty acids e.g., lactic acid, such as lauryl lactate and cetyl lactate.

Suitable fatty acid ester type emollients include those derived from C₁₂-C₂₈ fatty acids, such as C₁₆-C₂₂ saturated fatty acids, and short chain (C₁-C₈ and/or C₁-C₃) monohydric alcohols. Representative examples of such esters include methyl palmitate, methyl stearate, isopropyl laurate, isopropyl myristate, isopropyl palmitate, and ethylhexyl palmitate. Suitable fatty acid ester emollients can also be derived from esters of longer chain fatty alcohols (C₁₂-C₂₈ and/or C₁₂-C₁₆) and shorter chain fatty acids e.g., lactic acid, such as lauryl lactate and cetyl lactate.

Suitable alkyl ethoxylate type emollients include C₁₂-C₁₈ fatty alcohol ethoxylates having an average of from 3 to 30 oxyethylene units, such as from about 4 to about 23. Non-limiting examples of such alkyl ethoxylates include laureth-3 (a lauryl ethoxylate having an average of 3 oxyethylene units), laureth-23 (a lauryl ethoxylate having an average of 23 oxyethylene units), ceteth-10 (acetyl ethoxylate having an average of 10 oxyethylene units), steareth-2 (a stearyl ethoxylate having an average of 2 oxyethylene units) and steareth-10 (a stearyl ethoxylate having an average of 10 oxyethylene units). These alkyl ethoxylate emollients are typically used in combination with the petroleum-based emollients, such as petrolatum, at a weight ratio of alkyl ethoxylate emollient to petroleum-based emollient of from about 1:1 to about 1:3 and/or from about 1:1.5 to about 1:2.5.

The lotions of the present invention may include an “immobilizing agent”, so-called because they are believed to act to prevent migration of the emollient so that it can remain primarily on the surface of the fibrous structure to which it is applied so that it may deliver maximum softening benefit as well as be available for transferability to the user's skin. Suitable immobilizing agents for the present invention can comprise polyhydroxy fatty acid esters, polyhydroxy fatty acid amides, and mixtures thereof. To be useful as immobilizing agents, the polyhydroxy moiety of the ester or amide should have at least two free hydroxy groups. It is believed that these free hydroxy groups are the ones that co-crosslink through hydrogen bonds with the cellulosic fibers of the tissue paper web to which the lotion is applied and homo-crosslink, also through hydrogen bonds, the hydroxy groups of the ester or amide, thus entrapping and immobilizing the other components in the lotion matrix. Non-limiting examples of suitable esters and amides will have three or more free hydroxy groups on the polyhydroxy moiety and are typically nonionic in character. Because of the skin sensitivity of those using paper products to which the lotion is applied, these esters and amides should also be relatively mild and non-irritating to the skin.

Suitable polyhydroxy fatty acid esters for use in the present invention will have the formula:

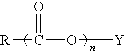

wherein R is a C₅-C₃₁ hydrocarbyl group, such as a straight chain C₇-C₁₉ alkyl or alkenyl and/or a straight chain C₉-C₁₇ alkyl or alkenyl and/or a straight chain C₁₁-C₁₇ alkyl or alkenyl, or mixture thereof; Y is a polyhydroxyhydrocarbyl moiety having a hydrocarbyl chain with at least 2 free hydroxyls directly connected to the chain; and n is at least 1. Suitable Y groups can be derived from polyols such as glycerol, pentaerythritol; sugars such as raffinose, maltodextrose, galactose, sucrose, glucose, xylose, fructose, maltose, lactose, mannose and erythrose; sugar alcohols such as erythritol, xylitol, malitol, mannitol and sorbitol; and anhydrides of sugar alcohols such as sorbitan.

One class of suitable polyhydroxy fatty acid esters for use in the present invention comprises certain sorbitan esters, such as sorbitan esters of C₁₆-C₂₂ saturated fatty acids.

Immobilizing agents include agents that are may prevent migration of the emollient into the fibrous structure such that the emollient remain primarily on the surface of the fibrous structure and/or sanitary tissue product and/or on the surface treating composition on a surface of the fibrous structure and/or sanitary tissue product and facilitate transfer of the lotion to a user's skin. Immobilizing agents may function as viscosity increasing agents and/or gelling agents.

Non-limiting examples of suitable immobilizing agents include waxes (such as ceresin wax, ozokerite, microcrystalline wax, petroleum waxes, fisher tropsh waxes, silicone waxes, paraffin waxes), fatty alcohols (such as cetyl, cetaryl, cetearyl and/or stearyl alcohol), fatty acids and their salts (such as metal salts of stearic acid), mono and polyhydroxy fatty acid esters, mono and polyhydroxy fatty acid amides, silica and silica derivatives, gelling agents, thickeners and mixtures thereof.

In one example, the lotion comprises at least one immobilizing agent and at least one emollient.

The lotion may be a transferable lotion. A transferable lotion comprises at least one component that is capable of being transferred to an opposing surface such as a user's skin upon use. In one example, at least 0.1% of the transferable lotion present on the user contacting surface transfers to the user's skin during use.

### Surface Treating Composition

A surface treating composition, for purposes of the present invention, is a composition that improves the tactile sensation of a surface, such as a surface of a fibrous structure perceived by a user whom holds a fibrous structure and/or sanitary tissue product comprising the fibrous structure and rubs it across the user's skin. Such tactile perceivable softness can be characterized by, but is not limited to, friction, flexibility, and smoothness, as well as subjective descriptors, such as a feeling like lubricious, velvet, silk or flannel.

The surface treating composition may or may not be transferable. Typically, it is substantially non-transferable.

The surface treating composition may increase or decrease the surface friction of the surface of the fibrous structure, especially the user contacting surface of the fibrous structure. Typically, the surface treating composition will reduce the surface friction of the surface of the fibrous structure compared to a surface of the fibrous structure without such surface treating composition.

The surface treating composition may have a wettability tension less than or equal to the surface tension of a lotion applied to a surface of a fibrous structure treated with the surface treating composition so as to minimize the spreading of the lotion that comes into contact with the surface treating composition and/or to reduce and/or inhibit migration of the lotion into the fibrous structure.

The surface treating composition comprises a surface treating agent. The surface treating composition during application to the fibrous structure may comprise at least about 0.1% and/or at least 0.5% and/or at least about 1% and/or at least about 3% and/or at least about 5% to about 90% and/or to about 80% and/or to about 70% and/or to about 50% and/or to about 40% by weight of the surface treating agent. In one example, the surface treating composition comprises from about 5% to about 40% by weight of the surface treating agent.

A bonded fibrous structure, such as a fibrous structure and/or sanitary tissue product comprising a fibrous structure according to the present invention may comprise at least about 0.01% and/or at least about 0.05% and/or at least about 0.1% of total basis weight of the surface treating agent. In one example, the fibrous structure and/or sanitary tissue product may comprise from about 0.01% to about 20% and/or from about 0.05% to about 15% and/or from about 0.1% to about 10% and/or from about 0.01% to about 5% and/or from about 0.1% to about 2% of total basis weight of the surface treating composition.

Non-limiting examples of suitable surface treating agents can be selected from the group consisting of: polymers such as polyethylene and derivatives thereof, hydrocarbons, waxes, oils, silicones, polysiloxanes, organosilicones (oil compatible), quaternary ammonium compounds, fluorocarbons, substituted C₁₀-C₂₂ alkanes, substituted C₁₀-C₂₂ alkenes, in particular derivatives of fatty alcohols and fatty acids (such as fatty acid amides, fatty acid condensates and fatty alcohol condensates), polyols, derivatives of polyols (such as esters and ethers), sugar derivatives (such as ethers and esters), polyglycols (such as polyethyleneglycol) and mixtures thereof.

In one example, the surface treating composition of the present invention is a microemulsion and/or a macroemulsion of a surface treating agent (for example an aminofunctional polydimethylsiloxane, specifically an aminoethylaminopropyl polydimethylsiloxane) in water. In such an example, the concentration of the surface treating agent within the surface treating composition may be from about 3% to about 60% and/or from about 4% to about 50% and/or from about 5% to about 40%. A non-limiting examples of such microemulsions are commercially available from Wacker Chemie (MR1003, MR103, MR102). A non-limiting example of such a macroemulsion is commercially available from General Electric Silicones (CM849).

Non-limiting examples of suitable waxes may be selected from the group consisting of: paraffin, polyethylene waxes, beeswax and mixtures thereof.

Non-limiting examples of suitable oils may be selected from the group consisting of: mineral oil, silicone oil, silicone gels, petrolatum and mixtures thereof.

Non-limiting examples of suitable silicones may be selected from the group consisting of: polydimethylsiloxanes, aminosilicones, cationic silicones, quaternary silicones, silicone betaines and mixtures thereof.

Non-limiting examples of quaternary ammonium compounds suitable for use in the present invention include the well-known dialkyldimethylammonium salts such as ditallowedimethylammonium chloride, ditallowedimethylammonium methylsulfate, di(hydrogenated tallow)dimethylammonium chloride. In one example, the surface treating composition comprises di(hydrogenated tallow)dimethylammonium chloride, commercially available from Witco Chemical Company Inc. of Dublin, Ohio as Varisoft 137®.

Non-limiting examples of ester-functional quaternary ammonium compounds having the structures named above and suitable for use in the present invention include the well-known diester dialkyl dimethyl ammonium salts such as diester ditallow dimethyl ammonium chloride, monoester ditallow dimethyl ammonium chloride, diester ditallow dimethyl ammonium methyl sulfate, diester di(hydrogenated)tallow dimethyl ammonium methyl sulfate, diester di(hydrogenated)tallow dimethyl ammonium chloride, and mixtures thereof. In one example, the surface treating composition comprises diester ditallow dimethyl ammonium chloride and/or diester di(hydrogenated)tallow dimethyl ammonium chloride, both commercially available from Witco Chemical Company Inc. of Dublin, Ohio under the tradename “ADOGEN SDMC”.

The surface treating composition may comprise additional ingredients such as a vehicle as described herein below which may not be present on the fibrous structure and/or sanitary tissue product comprising such fibrous structure. In one example, the surface treating composition may comprise a surface treating agent and a vehicle such as water to facilitate the application of the surface treating agent onto the surface of the fibrous structure.

### Skin Benefit Agent

One or more skin benefit agents may be included in the lotion of the present invention. If a skin benefit agent is included in the lotion, it may be present in the lotion at a level of from about 0.5% to about 80% and/or 0.5% to about 70% and/or from about 5% to about 60% by weight of the lotion.

Non-limiting examples of skin benefit agents include zinc oxide, vitamins, such as Vitamin B3 and/or Vitamin E, sucrose esters of fatty acids, such as Sefose 1618S (commercially available from Procter & Gamble Chemicals), antiviral agents, anti-inflammatory compounds, lipid, inorganic anions, inorganic cations, protease inhibitors, sequestration agents, chamomile extracts, aloe vera, calendula officinalis, alpha bisalbolol, Vitamin E acetate and mixtures thereof.

Non-limiting examples of suitable skin benefit agents include fats, fatty acids, fatty acid esters, fatty alcohols, triglycerides, phospholipids, mineral oils, essential oils, natural oils, sterols, sterol esters, emollients, waxes, humectants and combinations thereof.

In one example, the skin benefit agent may be any substance that has a higher affinity for oil over water and/or provides a skin health benefit by directly interacting with the skin. Suitable examples of such benefits include, but are not limited to, enhancing skin barrier function, enhancing moisturization and nourishing the skin.

The skin benefit agent may be alone, included in a lotion and/or included in a surface treating composition. A commercially available lotion comprising a skin benefit agent is Vaseline® Intensive Care Lotion (Chesebrough-Pond's, Inc.).

### Other Ingredients

Other optional ingredients that may be included in the lotion include vehicles, perfumes, especially long lasting and/or enduring perfumes, antibacterial actives, antiviral actives, disinfectants, pharmaceutical actives, film formers, deodorants, opacifiers, astringents, solvents, cooling sensate agents, such as camphor, thymol and menthol, warming sensate agents, such as polyhydric alcohols (propylene glycol, butylene glycol, hexylene glycol, polyethylene glycol), vanilla alcohol n-butylether, vanillyl alcohol n-propylether, vanillyl alcohol isopropylether, vanillyl alcohol isobutylether, vanillyl alcohol n-aminoether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine.

### Vehicle

As used herein a “vehicle” is a material that can be used to dilute and/or emulsify agents forming the surface treating composition and/or lotion to form a dispersion/emulsion. A vehicle may be present in the surface treating composition and/or lotion, especially during application of the surface treating composition and/or to the fibrous structure. A vehicle may dissolve a component (true solution or micellar solution) or a component may be dispersed throughout the vehicle (dispersion or emulsion). The vehicle of a suspension or emulsion is typically the continuous phase thereof. That is, other components of the dispersion or emulsion are dispersed on a molecular level or as discrete particles throughout the vehicle.

Suitable materials for use as the vehicle of the present invention include hydroxyl functional liquids, including but not limited to water. In one example, the lotion comprises less than about 20% and/or less than about 10% and/or less than about 5% and/or less than about 0.5% w/w of a vehicle, such as water. In one example, the surface treating composition comprises greater than about 50% and/or greater than about 70% and/or greater than about 85% and/or greater than about 95% and/or greater than about 98% w/w of a vehicle, such as water.

### Process Aids

Process aids may also be used in the lotions of the present invention. Non-limiting examples of suitable process aids include brighteners, such as TINOPAL CBS-X®, obtainable from CIBA-GEIGY of Greensboro, N.C.

### Methods for Making Multi-Ply Fibrous Structures

In one example, as shown in FIG. 4, a method for making a multi-ply fibrous structure 24 comprises the step of plybonding a first fibrous structure ply 26 to a second fibrous structure ply 28 via an adhesive 30 to form a multi-ply fibrous structure 24. The step of plybonding may comprise applying an adhesive 30 to a surface 32 of the first fibrous structure ply 26. In addition, the step of plybonding may comprise applying an adhesive 30 to a surface 34 of the second fibrous structure ply 28. The adhesive 30 may be applied by any suitable means, such as by extrusion, spraying, dipping, printing and brushing, from an adhesive source 36. The plybonding step may further comprise associating the adhesive 30 present on surface 32 with the surface 34 to form a multi-ply fibrous structure 24. In one example, the first and second fibrous structure plies 26, 28 are combined together by passing through a nip formed by two rolls 38, 40 such that pressure is applied to the plies 26, 28 where the adhesive 30 is present resulting in the formation of the multi-ply fibrous structure 24. In one example, the adhesive is applied using spraying equipment commercially available from Spraying Systems Inc.

Once the multi-ply fibrous structure 24 is formed, a lotion 42 is applied to the multi-ply fibrous structure 24. The lotion 42 may be applied to the multi-ply fibrous structure by any suitable means, such as by extrusion, spraying, dipping, printing and brushing, from a lotion source 44.

The multi-ply fibrous structure 24 may then be convolutedly wound into a roll 46 and then further converted, if necessary, into finished product roll (not shown).

### Non-limiting Examples of Lotions

Example 1 of a Lotion:

| | | |
|---|---|---|
| Stearyl Alcohol | 40% | w/w |
| Petrolatum | 30% | w/w |
| Mineral Oil | 30% | w/w |

Example 2 of a Lotion:

| | | |
|---|---|---|
| Mineral Oil | 55% | w/w |
| Paraffin | 12% | w/w |
| Cetaryl Alcohol | 21% | w/w |
| Steareth-2 | 11% | w/w |
| Skin Benefit Agent | 1% | w/w |

Example 3 of a Lotion:

| | | |
|---|---|---|
| Mineral Oil | 55.4% | w/w |
| Cetearyl Alcohol | 20.75% | w/w |
| Paraffin Wax | 11.86% | w/w |
| Steareth-2 | 10.77% | w/w |
| Skin Benefit Agents | 1.22% | w/w |

### Non-Limiting Example of a Multi-Ply Fibrous Structure of the Present Invention

The following Example illustrates a non-limiting example for a preparation of a multi-ply fibrous structure, in this case a multi-ply sanitary tissue product, according to the present invention, on a pilot-scale Fourdrinier fibrous structure making machine.

An aqueous slurry of Eucalyptus (Aracruz Brazilian bleached hardwood kraft pulp) pulp fibers is prepared at about 3% fiber by weight using a conventional repulper. This slurry is passed through a stock pipe toward a multi-layered, three-chambered headbox of a Fourdrinier wet laid papermaking machine.

Separately, an aqueous slurry of Eucalyptus fibers is prepared at about 3% by weight using a conventional re-pulper. This slurry is passed through a stock pipe toward the multi-layered, three-chambered headbox of a Fourdrinier wet laid papermaking machine.

Finally, an aqueous slurry of NSK (Northern Softwood Kraft) fibers of about 3% by weight is made up using a conventional re-pulper. This NSK slurry is passed through a refiner and is refined to a Canadian Standard Freeness (CSF) of about 500. The refined NSK is then directed through a stock pipe toward the multi-layered, three-chambered headbox of a Fourdrinier wet laid papermaking machine.

The NSK and eucalyptus fiber slurries are diluted with white water at the inlet of their respective fan pumps to consistencies of about 0.15% based on the total weight of the respective slurries. The three slurries are spread over the width of the Fourdrinier, but maintained as separate streams in the multi-chambered headbox until they are deposited onto a forming wire on the Fourdrinier.

The fibrous structure making machine has a layered headbox having a top chamber, a center chamber, and a bottom chamber. The eucalyptus fiber slurry is pumped through the top headbox chamber, the eucalyptus fiber slurry is pumped through the bottom headbox chamber (i.e. the chamber feeding directly onto the forming wire) and, finally, the NSK fiber slurry is pumped through the center headbox chamber and delivered in superposed relation onto the Fourdrinier wire to form thereon a three-layer embryonic web, of which about 33% of the top side is made up of the eucalyptus blended fibers, about 33% is made of the eucalyptus fibers on the bottom side and about 33% is made up of the NSK fibers in the center. Dewatering occurs through the Fourdrinier wire and is assisted by a deflector and vacuum boxes. The Fourdrinier wire is of an Asten Johnson 866A. The speed of the Fourdrinier wire is about 2650 feet (807.7 m) per minute (fpm).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a large pillow patterns surrounded by a continuous network of high density (knuckle) areas. This drying fabric is formed by casting an impervious resin surface onto a fiber mesh supporting fabric. The supporting fabric is a 98×62 filament, dual layer mesh. The thickness of the resin cast is about 10 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 65% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry-creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 332° F. (166.6° C.) and a speed of about 2650 fpm (807.7 m/min). The fibrous structure is wound in a roll using a surface driven reel drum having a surface speed of about 2255 fpm (687.3 m/min). The fibrous structure may be subsequently converted into a two-ply sanitary tissue product.

Two parent rolls of the fibrous structure are loaded on the unwind stand of a combiner to combine plies into two-plies. The combiner is run at 1900 feet per minute (579.1 m/min.). The glue header applies ply-bond glue coverage at 1 nozzle per roll position. The ply-bond glue (HB Fuller's TT5000B) is applied to the non-consumer side of the fibrous structure at a rate of about 4.5 mg/meter at each roll position. The combined two-ply fibrous structure then passes over a set of extrusion headers at a speed of 1900 feet per minute (579.1 m/min.) where a surface treating composition, in this case silicone, is applied on the both consumer-sides of the combined fibrous structure at a total add-on level of 5100 ppm (parts per million). The combined, two-ply fibrous structure then passes over a second set of extrusion headers at a speed of 1900 feet per minute (579.1 m/min.) where lotion is applied to both consumer-sides of the fibrous structure at a total add-on level of about 3.0 lbs per 3000 ft² ream. The combined, two-ply fibrous structure with lotion is then wound into a parent roll at the rewind at a speed of 1900 feet per minute (579.1 m/min.).

The combined, two-ply parent roll with lotion is loaded onto the unwind stand of the converting line. The combined, two-ply fibrous structure with lotion is passed through a perforation station where it is perforated and rewound into logs of desired finished product roll length and sheet length at a speed of 1479 feet per minute (450.8 m/min.).

The logs are transferred to a log saw where they are cut into finished product rolls of the desired consumer width. The resulting multi-ply sanitary tissue paper product is very soft, flexible and absorbent.

### Test Methods

Unless otherwise indicated, all tests described herein including those described under the Definitions section and the following test methods are conducted on samples, test equipment and test surfaces that have been conditioned in a conditioned room at a temperature of about 73° F.±4° F. (about 23° C.±2.2° C.) and a relative humidity of 50%±10% for 24 hours prior to the test. Further, the tests are conducted in the conditioned room.

### Horizontal Full Sheet (HFS) Test Method

The Horizontal Full Sheet (HFS) test method determines the amount of distilled water absorbed and retained by a fibrous structure of the present invention. This method is performed by first weighing a sample of the fibrous structure to be tested (referred to herein as the “dry weight of the sample”), then thoroughly wetting the sample, draining the wetted sample in a horizontal position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the HFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sample tested (i.e.; a fibrous structure sample of about 10.16 cm by 10.16 cm). The balance pan can be made out of a variety of materials. Plexiglass is a common material used.

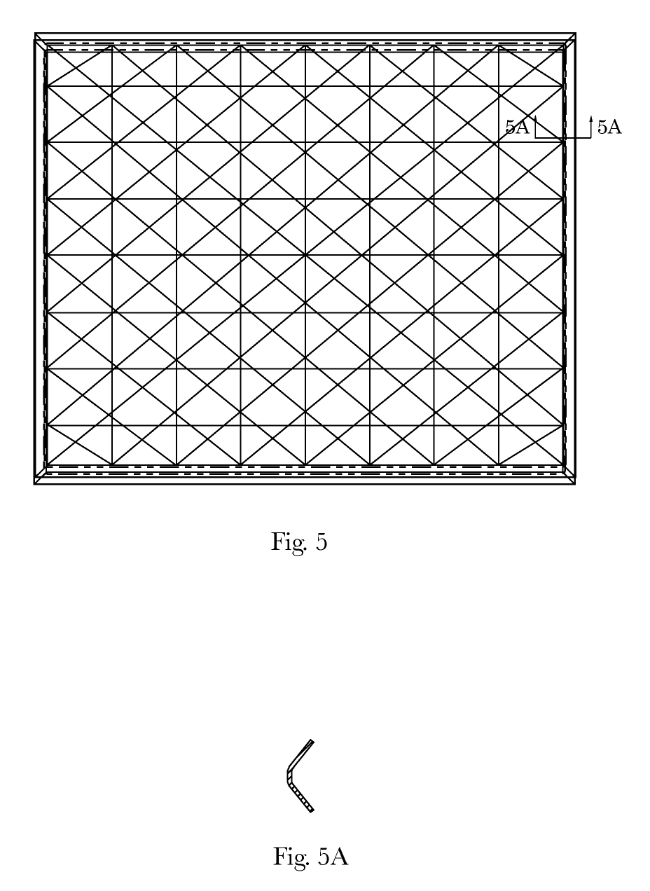

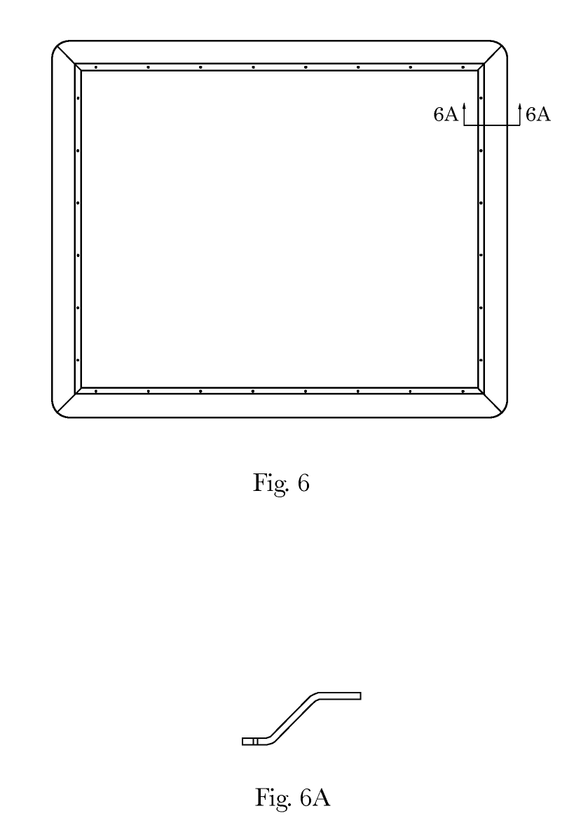

2) A sample support rack (FIG. 5) and sample support rack cover (FIG. 6) is also required. Both the rack and cover are comprised of a lightweight metal frame, strung with 0.38 mm diameter monofilament so as to form a grid as shown in FIG. 5. The size of the support rack and cover is such that the sample size can be conveniently placed between the two.

A water reservoir or tub is filled with distilled water at 23° C.±2.2° C. to a depth of 7.6 cm.

Six samples of a fibrous structure to be tested are carefully weighed on the balance to the nearest 0.01 grams Make sure that the samples do not touch the walls or glass doors of the balance. The dry weight of each sample is reported to the nearest 0.01 grams. The empty sample support rack is placed on the balance with the special balance pan described above. The balance is then zeroed (tared). The six samples are individually placed on the sample support rack roughly centered so that there are two separate rows of three 10.16 cm by 10.16 cm samples each. The uppermost row will consist of three samples with the distance between each sample and the sides of the support rack evenly spaced, so that their machine direction is parallel to the longest dimension of the support rack. The lower row will consist of three samples with the distance between each sample and the sides of the support rack evenly distributed so that their cross direction is parallel to the longest dimension of the support rack. The support rack cover is placed on top of the support rack. The samples (now sandwiched between the rack and cover) are submerged in the water reservoir. After the samples are submerged for 10 seconds, the sample support rack and cover are gently raised out of the reservoir.

The samples, support rack and cover are allowed to drain horizontally for 120±5 seconds, taking care not to excessively shake or vibrate the sample. While the samples are draining, the rack cover is carefully removed and all excess water is wiped from the support rack. Thoroughly dry all the surfaces of the support rack without drying the wet samples. Small droplets of water may adhere to the nylon threads, but these are of no concern as their weight will be insignificant.

The wet samples and the support rack are then weighed on the previously tared balance. The weight is recorded to the nearest 0.01 g. This is the wet weight of the sample.

The gram per fibrous structure sample absorptive capacity of the sample is defined as (wet weight of the sample−dry weight of the sample). The horizontal absorbent capacity (HAC) (“RFS”) is defined as: absorbent capacity=(wet weight of the sample−dry weight of the sample)/(dry weight of the sample) and has a unit of gram/gram. Repeat the entire procedure for a second set of samples. Calculate the average HFS from the HFS values obtained from the two sets of samples and report the average HFS value as the HFS value for the sample.

### Vertical Full Sheet (VFS) Test Method

The Vertical Full Sheet (VFS) test method determines the amount of distilled water absorbed and retained by a fibrous structure of the present invention. This method is performed by first weighing a sample of the fibrous structure to be tested (referred to herein as the “dry weight of the sample”), then thoroughly wetting the sample, draining the wetted sample in a vertical position and then reweighing (referred to herein as “wet weight of the sample”). The absorptive capacity of the sample is then computed as the amount of water retained in units of grams of water absorbed by the sample. When evaluating different fibrous structure samples, the same size of fibrous structure is used for all samples tested.

The apparatus for determining the VFS capacity of fibrous structures comprises the following:

1) An electronic balance with a sensitivity of at least ±0.01 grams and a minimum capacity of 1200 grams. The balance should be positioned on a balance table and slab to minimize the vibration effects of floor/benchtop weighing. The balance should also have a special balance pan to be able to handle the size of the sample tested (i.e.; a fibrous structure sample of about 10.16 cm by 10.16 cm). The balance pan can be made out of a variety of materials. Plexiglass is a common material used.

2) A sample support rack (FIG. 5) and sample support rack cover (FIG. 6) is also required. Both the rack and cover are comprised of a lightweight metal frame, strung with 0.38 mm diameter monofilament so as to form a grid as shown in FIG. 5. The size of the support rack and cover is such that the sample size can be conveniently placed between the two.

A water reservoir or tub is filled with distilled water at 23° C.±2.2° C. to a depth of 7.6 cm.

Six samples of a fibrous structure to be tested are carefully weighed on the balance to the nearest 0.01 grams Make sure that the samples do not touch the walls or glass doors of the balance. The dry weight of each sample is reported to the nearest 0.01 grams. The empty sample support rack is placed on the balance with the special balance pan described above. The balance is then zeroed (tared). The six samples are individually placed on the sample support rack roughly centered so that there are two separate rows of three 10.16 cm by 10.16 cm samples each. The uppermost row will consist of three samples with the distance between each sample and the sides of the support rack evenly spaced, so that their machine direction is parallel to the longest dimension of the support rack. The lower row will consist of three samples with the distance between each sample and the sides of the support rack evenly distributed so that their cross direction is parallel to the longest dimension of the support rack. The support rack cover is placed on top of the support rack. The samples (now sandwiched between the rack and cover) are submerged in the water reservoir. After the samples are submerged for 10 seconds, the sample support rack and cover are gently raised out of the reservoir.

The samples, support rack and cover are allowed to drain horizontally for 120±5 seconds, taking care not to excessively shake or vibrate the sample. While the samples are draining, the rack cover is carefully removed and all excess water is wiped from the support rack. After the 120±5 seconds horizontal draining, carefully grasp the support rack containing the wet samples and bring it to a vertical position. Allow the samples and support rack to drain vertically for 60±5 seconds. At the end of the vertical draining, carefully grasp the support rack containing the wet samples and bring it to a horizontal position, holding by hand. Thoroughly dry all the surfaces of the support rack without drying the wet samples. Small droplets of water may adhere to the nylon threads, but these are of no concern as their weight will be insignificant.

The wet samples and the support rack are then weighed on the previously tared balance. The weight is recorded to the nearest 0.01 g. This is the wet weight of the sample.

The gram per fibrous structure sample absorptive capacity of the sample is defined as (wet weight of the sample−dry weight of the sample). The vertical absorbent capacity (VAC) (“VFS”) is defined as: absorbent capacity=(wet weight of the sample−dry weight of the sample)/(dry weight of the sample) and has a unit of gram/gram.

Repeat the entire procedure for a second set of samples. Calculate the average VFS from the VFS values obtained from the two sets of samples and report the average VFS value as the VFS value for the sample.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and describe, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A multi-ply fibrous structure comprising a first fibrous structure ply and a second fibrous structure ply plybonded together by an adhesive wherein at the multi-ply fibrous structure further comprises a lotion.

2. The multi-ply fibrous structure according to claim 1 wherein at least one of the first and second fibrous structure plies comprises a through-air-dried fibrous structure ply.

3. The multi-ply fibrous structure according to claim 1 wherein at least one of the first and second fibrous structure plies comprises regions of differential density.

4. The multi-ply fibrous structure according to claim 1 wherein at least one of the first and second fibrous structure plies is uncreped.

5. The multi-ply fibrous structure according to claim 1 wherein the adhesive is selected from the group consisting of: cold glues, liquid hot melt glues and mixtures thereof.

6. The multi-ply fibrous structure according to claim 1 wherein the adhesive comprises polyvinyl alcohol.

7. The multi-ply fibrous structure according to claim 1 wherein the lotion comprises an ingredient selected from the group consisting of: oils, waxes and mixtures thereof.

8. The multi-ply fibrous structure according to claim 1 wherein the lotion is transferable.

9. The multi-ply fibrous structure according to claim 1 wherein the lotion comprises a skin benefit agent.

10. The multi-ply fibrous structure according to claim 1 wherein the lotion comprises an alcohol.

11. The multi-ply fibrous structure according to claim 1 wherein the multi-ply fibrous structure comprises a surface treating composition.

12. The multi-ply fibrous structure according to claim 11 wherein the surface treating composition is positioned between a surface of the multi-ply fibrous structure and the lotion.

13. The multi-ply fibrous structure according to claim 12 wherein the surface treating composition and lotion are phase registered with one another.

14. The multi-ply fibrous structure according to claim 1 wherein the lotion comprises aloe.

15. The multi-ply fibrous structure according to claim 1 wherein the lotion comprises shea butter.

16. The multi-ply fibrous structure according to claim 1 wherein at least one of the fibrous structure plies comprises a pattern.

17. The multi-ply fibrous structure according to claim 1 wherein at least one of the fibrous structure plies comprises an embossment.

18. A method for making a multi-ply fibrous structure according to claim 1, the method comprising the steps of:
a. plybonding a first fibrous structure ply with a second fibrous structure ply with an adhesive to form a multi-ply fibrous structure; and
b. applying a lotion to at least one of the first and second fibrous structure plies.

19. A fibrous structure comprising a lotion, wherein the fibrous structure exhibits a HFS of greater than 18.2 g/g.

20. A fibrous structure comprising a lotion wherein the fibrous structure exhibits a VFS of greater than 9.7 g/g.
